(19) United States
(12) Patent Application Publication
(10) Pub. No.: US 2016/0081884 A1
(43) Pub. Date: Mar. 24, 2016

(54) TEAT FOR AN INFANT FEEDING BOTTLE

(71) Applicant: KONINKLIJKE PHILIPS N.V., EINDHOVEN (NL)

(72) Inventors: Jason PALMER, Eindhoven (NL); Bart-Jan ZWART, Eindhoven (NL); Christopher John HUFF, Eindhoven (NL); Jacob BRINKERT, Eindhoven (NL)

(21) Appl. No.: 14/388,273

(22) PCT Filed: Apr. 3, 2013
(86) PCT No.: PCT/IB2013/052657

§ 371 Date: Sep. 26, 2014

Related U.S. Application Data
(60) Provisional application No. 61/620,674, filed on Apr. 5, 2012.

(30) Foreign Application Priority Data
Apr. 5, 2012 (EP) 12163360.6

(51) Int. Cl. A61J 11/02; A61J 11/00

(52) U.S. Cl. CPC A61J 11/02; A61J 11/0035

(57) ABSTRACT

A teat (10) for an infant feeding bottle (1), including a resilient wall (12) defining a central nipple (14a) and an areola (14b) that extend around a central axis (L), said teat being elastically transformable between a distended state in which the nipple defines a global maximum (38) and at least one depressed state that is accessible from the distended state by forcing the nipple at least partially into the areola along the central axis, and in which said wall (12) additionally defines an annular double fold (32) that defines an outer local maximum (34) and an inner local minimum (36), both extending circumferentially around the global maximum, wherein the wall defines a circumferential fold region (30) that, in said at least one depressed state, ranges from the local maximum to the local minimum of the double fold, and wherein said fold region has a rotationally asymmetric stiffness distribution.

### FIELD OF THE INVENTION

The present invention relates to a teat for an infant feeding bottle, and to an infant feeding bottle provided with such a teat.

### BACKGROUND

Infant feeding bottles may typically include a bottle body for containing milk or a liquid infant formula, and a teat that is attached to the bottle body such that the bottle body's contents may be fed therethrough to an infant. During feeding, the discharge of food from the bottle may cause an external-internal pressure differential across a resilient wall of the teat, as a result of which the teat may deform. This deformation of the teat may frustrate the nursing of the infant.

### SUMMARY OF THE INVENTION

The acceptance of an artificial teat by an infant may be improved by having its shape and feel resemble that of a natural mother's breast. To this end, the wall of the teat, and specifically a wall portion thereof defining an areola that surrounds a nipple, may be made extra flexible and hence soft to the touch, as in, for instance, DE 20 2011 052 329-U1. A drawback of such softening of the areola is that smaller external-internal pressure differences may cause deformation of the teat from a distended state into a depressed state. In such a latter state, the nipple may be partially retracted into the areola (at least relative to the distended state), such that it is no longer freely available to the lips of the infant and feeding becomes difficult or impossible.

For clarity, it is noted that ‘depression’ or ‘retraction’ of the teat is to be distinguished from ‘collapse’ of the teat, during which opposite wall portions defining the nipple of the teat move towards and contact each other, thus impeding or even cutting off the milk flow through the nipple. An example of a publication dealing with the issue of teat collapse is US 2012/0074090-A1. While depression of the teat is almost exclusively caused by a reduced pressure within the feeding bottle, collapse of the nipple may additionally and often primarily be caused by pressure exerted on the outside of the nipple by an infant's lips, gums or teeth. Depression of the teat may occur without collapse of the teat, and vice versa, and the two phenomena may therefore be considered generally unrelated.

Some known feeding bottle designs intend to avoid the above-described depression of the teat by the provision of a valve that opens under the influence of a negative external-internal pressure differential and then allows air into the bottle, thereby preventing any vacuum build-up therein. In practice, however, such valves may not be fully reliable, for instance because they may get clogged with milk residue. Furthermore, in particular when the teat is generally axisymmetric, the deformed and therefore stressed wall of a depressed teat may be incapable of forcing the teat back into its distended position, even when the pressures on both sides of the teat wall have been equalized. Consequently, it may be necessary to manually pull the nipple from its retracted position so as to restore the distended state of the teat. This is not only inconvenient, but may also be unhygienic.

It is therefore an object of the present invention to provide for a teat for an infant feeding bottle that overcomes or mitigates the abovementioned problem. More specifically, it is an object of the present invention to provide for a teat that reliably and automatically returns from its depressed state to its distended state after the pressure differential across the teat wall that caused the retraction in the first place has been neutralized, even in case the teat possesses a high degree of rotational symmetry.

To this end, a first aspect of the present invention is directed to a teat for an infant feeding bottle. The teat may include a resilient wall defining a central nipple and an areola, both of which may extend around a central axis. The teat may be elastically transformable between a distended state in which the nipple defines a global maximum, and at least one depressed state that is accessible from the distended state by forcing the nipple at least partially into the areola along the central axis, and in which said wall additionally defines an annular double fold that is absent in the distended state. The annular double fold may define an outer local maximum and an inner local minimum, both of which may extend circumferentially around the global maximum defined by the nipple. The wall may further define a circumferential fold region that, in said at least one depressed state, ranges from the local maximum to the local minimum of the double fold. This fold region may have a rotationally asymmetric stiffness distribution.

In general, a transition of the teat from its distended state into a depressed state may give rise to the formation of an annular double fold in the fold region of the teat wall. Since the teat wall may have a finite stiffness, while the respective fold region, as seen in a cross-sectional plane including the central axis of the teat, may typically include a curvature, the transition of the teat from its distended state into the depressed state may entail a forceful deformation of the fold region, so as to press a relatively large fold region area through a confined annular underlying area, disposed in a plane transverse to the axis of the teat and radially in between the later local maximum and local minimum of the double fold. The deformation of the fold region may thus entail temporary displacement of wall material towards the central axis of the teat, which results in a compressive stress in the teat wall in the circumferential or tangential direction. Upon passing the annular underlying area, however, the stress in the teat wall may be released, and the material in the fold region may return to its approximate original diameter (i.e. its diameter in the distended state), beit at a different, lower axial position. Although the distended state, in which the teat wall is substantially relaxed, may represent an elastic-energy minimum that is lower than that of the depressed state, in which the teat wall is partly deformed, the compressive state in between them may form a barrier to free transition. Accordingly, the distended state may be characterized as a stable equilibrium of the teat, while the depressed state may be characterized as a metastable equilibrium that is separated from the stable equilibrium by the intermediate compressive state. The metastability of the depressed state may in particular be present in a conventional teat having a softened areola and a generally axisymmetric shape. This is because the elastic stresses in the fold region of the teat wall in such a teat may, on the one hand, be relatively small, and, on the other hand, be symmetrically distributed around the central axis. The symmetry may effectively raise the barrier defined by the compressive state (since the elastic deformation stresses counteract each other in attempts of the teat wall to relax), and leave elastic stresses in the wall incapable to effect the transition from the depressed state back to the distended state, thus fostering the metastability of the former. The present invention overcomes the problem of metastability of the depressed state by introducing a rotationally asymmetric stiffness distribution in the fold region of the teat wall, optionally without affecting either the general axisymmetric shape of the teat or the sometimes desired softening of its areola. The rotationally asymmetric stiffness distribution in the fold region of the teat wall may ensure that, in a depressed state, an asymmetry exists in the elastic stresses present in the deformed wall. Fold region portions with a higher stiffness may exert greater (and thus partly unbalanced) restoring forces than fold region portions with a smaller stiffness, and thus force the nipple out of the areola through an asymmetrical transition path, as will be clarified in more detail infra. It is understood that the precise magnitude of the stiffness variations in the fold region may be selected depending on the concrete design of the teat, but are to be chosen such that no metastable depressed state can exist, at least not in the absence of an external-internal pressure differential across the teat wall.

It is noted for clarity that the above-described forceful entry of a depressed state may, but need not necessarily, occur under typical operating conditions, in particular due to an external-internal fluid or gas pressure differential across the teat wall as a result of discharge of food from the feeding bottle. The teat may, for instance, alternatively be forced into a depressed state through mechanical manipulation.

In one embodiment, the at least one depressed state is a maximally depressed state in which the nipple is forced down into the areola up to the point that the global maximum it defines equals i.e. is/extends at an equal axial level/position as the local maximum defined by the double fold. For typical teat designs this maximally depressed state may represent the limit beyond which no metastable depressed state can exist under practical operation conditions.

Defining the fold region of the teat with respect to its maximally depressed state ensures that the fold region covers all fold regions associated with less than maximally depressed states. Providing the thus defined fold region with a rotationally asymmetrical stiffness distribution that extends over substantially its entire width may therefore prevent metastable depression of the teat during practical use.

The rotationally asymmetric stiffness distribution of the teat wall in the fold region may be effected in different ways.

In one embodiment, the rotationally asymmetric stiffness distribution in the fold region may be at least partially effected through a rotationally asymmetric wall thickness distribution in said region. The fold region may, for instance, include a rotationally asymmetric arrangement of wall thickness-defined structures, e.g. protrusions or recesses. The effectuation of a rotationally asymmetric stiffness distribution by means of wall thickness-defined structures offers the advantage that the teat may be manufactured from a single, homogenous material. This enables the teat to be manufactured very economically.

In another embodiment, the rotationally asymmetric stiffness distribution may be at least partially effected through the use of a rotationally asymmetric distribution of at least two materials having a mutually different modulus of elasticity. In such an embodiment the fold region of the teat, which may be generally made of a first constituent material, may, for instance, include rotationally asymmetrically distributed ‘inlays’ or patches of a second constituent material having a modulus of elasticity that differs from that of the first. An advantage of such an embodiment is that it does not require shape-asymmetries to effect a rotationally asymmetric stiffness distribution in the belt region.

A second aspect of the present invention is directed to an infant feeding bottle provided with a teat according to the first aspect of the present invention. Aside from the teat, the feeding bottle may typically include a bottle body for containing a liquid food, and a screw ring by means of which the teat may be sealingly connected to the bottle body.

These and other features and advantages of the invention will be more fully understood from the following detailed description of certain embodiments of the invention, taken together with the accompanying drawings, which are meant to illustrate and not to limit the invention.

### BRIEF DESCRIPTION OF THE DRAWINGS

FIG. 1 is a schematic side view of an infant feeding bottle, including an exemplary embodiment of a teat according to the present invention;

FIG. 2A-D schematically show a perspective view, a side view, a bottom view and a bottom perspective view, respectively, of the isolated exemplary embodiment of the teat shown in FIG. 1;

FIG. 3A-B schematically show a longitudinal cross-sectional side view of the exemplary embodiment of the teat shown in FIGS. 1-2, wherein the teat is depicted in its distended state and a depressed state, respectively; and

FIG. 4 schematically illustrates how the teat of FIGS. 1-3 may elastically transform from its depressed state, schematically shown in FIG. 3B, back to its distended state, schematically shown in FIG. 3A.

### DETAILED DESCRIPTION

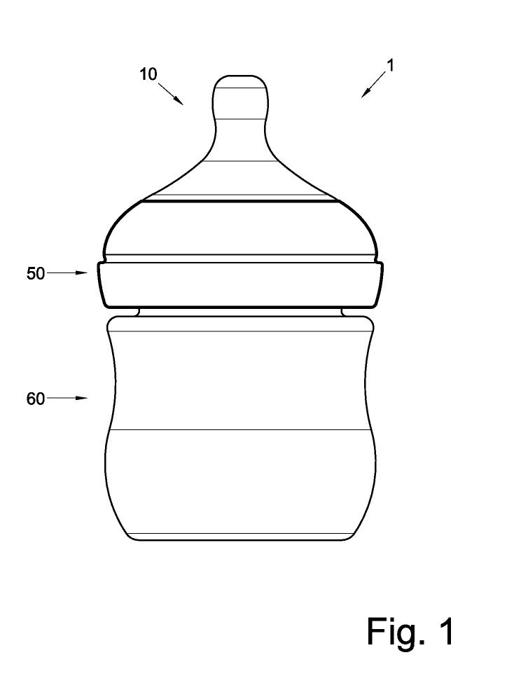

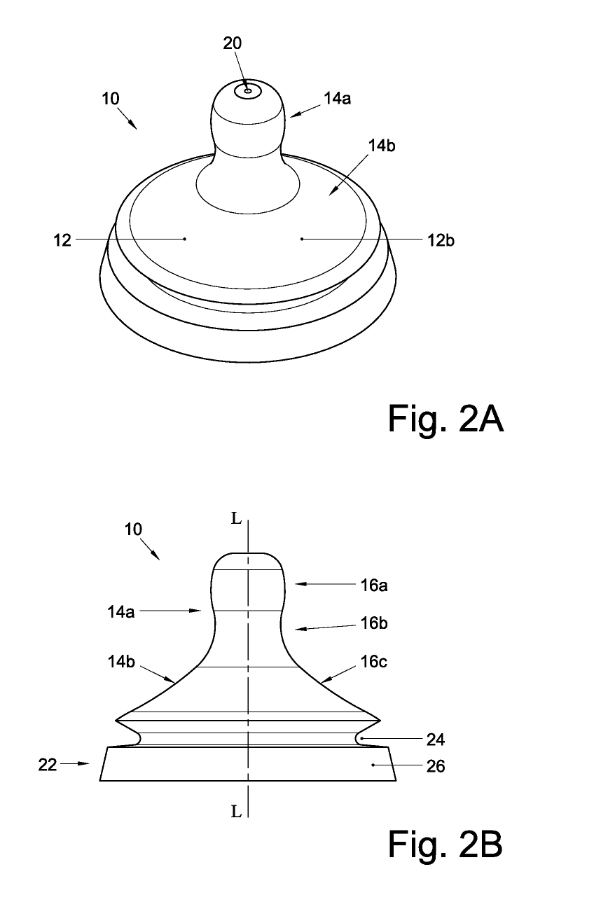

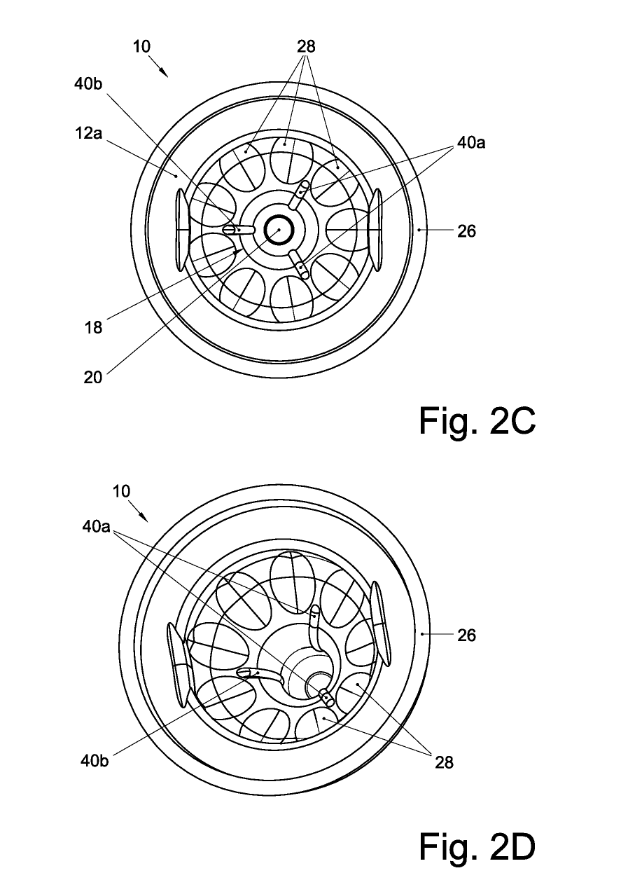

FIG. 1 depicts a schematic side view of an exemplary infant feeding bottle 1. The bottle 1 may have a three-part design and include a bottle body 60, a screw ring 50, and a resilient teat 10. The substantially hollow bottle body 60, configured to contain a liquid infant food, may include an upper portion (invisible in FIG. 1) provided with an outer screw thread that is engageable by an inner screw thread provided on an inner wall of a passage through the screw ring 50, such that the screw ring 50 is screwingly attachable to the upper portion of the bottle body 60. The inner passage of the screw ring 50 may further define an upper, constricted opening with a circumferential rim or edge that is configured to sealingly engage a lower portion or skirt 22 of the teat 10 (see FIG. 2B). In case the teat 10, which will be described in more detail below, is properly inserted into the screw ring 50, and the screw ring 50 is in turn screwingly attached to the bottle body 60, the infant feeding bottle shown in FIG. 1 may be obtained. The bottle body 60 and the screw ring 50 may in themselves be of a conventional construction and will therefore not be elaborated upon here any further.

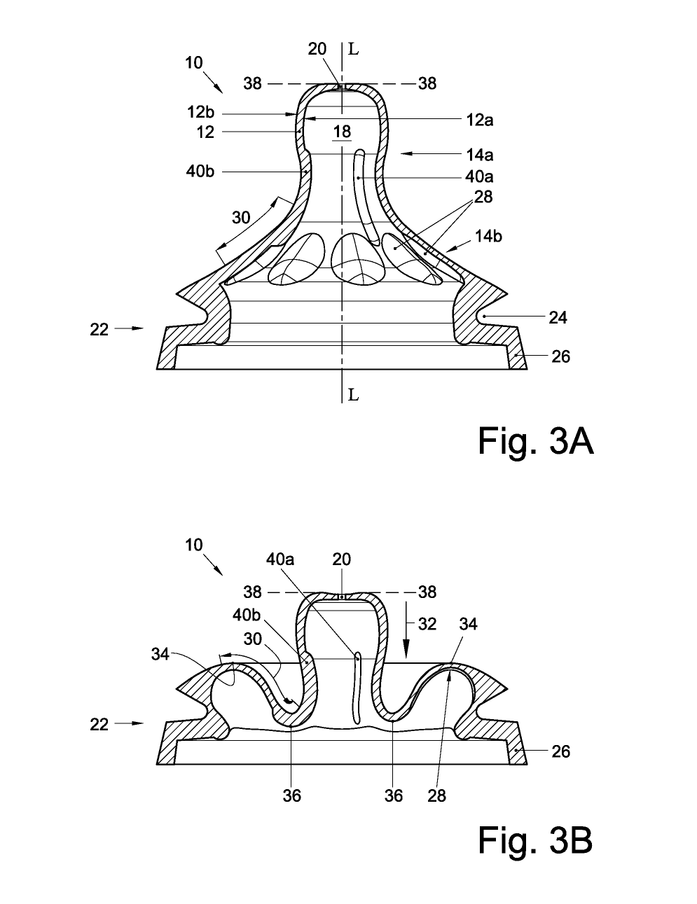

FIGS. 2A-D show the resilient teat 10 in isolation, respectively in a schematic perspective view, side view, bottom view and bottom perspective view. In addition, FIGS. 3A-B schematically show longitudinal cross-sectional side views of the teat 10, wherein the teat is respectively depicted in its distended state and in a depressed state. The construction of the teat 10 according to the present invention will now be discussed in general terms, where appropriate with reference to the exemplary embodiment illustrated in both FIGS. 2A-D and FIGS. 3A-B.

The anatomy of the teat 10 may include a skirt or base 22, an areola 14b, positioned on top of the skirt 22, and a nipple 14a that, at least in a distended state of the teat 10, may protrude substantially centrally from the areola 14b. An inner surface 12a of the teat wall 12 defining the nipple 14a and the areola 14b may define an interior food reception space 18, and the nipple 14a may define at least one food discharge opening 20. As is illustrated in FIG. 2B, the structure of the nipple 14a and areola 14b may be described in some more detail in terms of a head 16a, a neck 16b and a shoulder 16c. Accordingly, the nipple 14a may define the head 16a, while the areola 14b may define the shoulder 16c, and at least one of the nipple 14a and the areola 14b may define the neck 16b that connects the head 16a to the shoulder 16c.

The skirt 22 of the teat 10 may serve to connect it to the screw ring 50, shown in FIG. 1. To that end, the skirt may define an annular groove or recess 24 configured to receive a rim defining a top opening of a passage through the screw ring 50, and a clamp portion 26 configured to pressingly engage an inner wall of that passage so as to fluid tightly seal the connection between the teat 10 and the screw ring 50.

As regards the overall form of the teat 10 the following may be noted. The teat 10 may have a generally axisymmetric shape, at least on the outside. That is, an outer surface 12b of a resilient, deformable wall 12 defining the teat 10 may be axisymmetric (aside from optional, structurally irrelevant embossings), while the inner surface 12a of the wall 12 may or may not be. Furthermore, in the depicted embodiment, the neck 16b and shoulder 16c of the teat 10 are substantially outwardly concave. It is contemplated, however, that alternative embodiments of the teat 10 may include a substantially outwardly convex neck 16b and shoulder 16c, or a substantially outwardly concave neck 16b in combination with a substantially outwardly convex shoulder 16. To provide the teat 10 with an organic shape that is easy and friendly to latch on to for an infant during feeding, the neck 16b may preferably be substantially outwardly concave, such that it defines a slight constriction. More specifically, in a preferred embodiment the head 16a may have a maximum outer diameter D_{head,max}, while the neck 16b may have a minimum outer diameter D_{neck,min}, and the shoulder 16c may have a minimum outer diameter D_{shoulder,min} and a maximum outer diameter D_{shoulder,max}, such that D_{shoulder,max}>D_{shoulder,min}>D_{head,max}≧D_{neck,min}.

In one embodiment, the areola 14b of the teat 10 may be softened, i.e. made less stiff and more pliable and thus softer to the touch, for instance by the provision of a plurality of recesses in the inner surface 12a of the wall 12, which recesses 28 may extend in a circumferential, it itself rotationally symmetrical arrangement around the longitudinal axis L of the teat 10. In the depicted embodiment, the recesses 28 are all identical, regularly spaced apart in the tangential direction, and ovoidally shaped. An inner face of the ovoidal recess 28 may each time be generally concave. It is understood, however, that softening of the areola 14b of the teat 10 may be accomplished through a variety of alternative means. One such alternative means may, for example, include a teat wall portion that defines a band of reduced wall thickness that extends tangentially around the longitudinal axis L of the teat 10, and describes a sinusoidal or otherwise wave-shaped path (highs and lows being spaced apart in the axial direction).

In another embodiment, the nipple 14a of the teat 10, and in particular the neck portion 16b thereof, may be reinforced to prevent it from collapsing during use. To this end, the surface 12a, 12b of the wall 12 in the neck region 16b may, for instance, be provided with a plurality of ribs. The ribs may typically extend along the neck 16b, either in a direction with a mere radial and/or axial component, or helically, in a direction that additionally includes a tangential component. The plurality of ribs may be provided in a circumferential, in itself rotationally symmetric arrangement, and the ribs may be mutually identical.

It is noted for clarity that the provision of such a rotationally symmetric arrangement of ribs in the neck 16b of a teat 10 is known in the art as a measure against collapse of the teat. In the depicted embodiment of the teat 10, however, the inner surface 12a of the teat wall 12 features a rotationally a-symmetric arrangement of ribs 40a, 40b, including two ‘thin’ ribs 40a and one ‘thick’ rib 40b, which extend not only in the neck 16b of the teat 10 but also in its shoulder 16c. The purpose of the arrangement of the ribs 40a, 40b is to prevent both collapse of the neck portion 16b of the nipple 14a, and metastable depression of the nipple 14a into the areola 14b.

For a fuller understanding of this latter function, to which the aforementioned asymmetry of the arrangement is important, attention is invited to in particular FIGS. 3A-B, which, as mentioned, schematically show longitudinal cross-sectional side views of the teat 10, wherein the teat is respectively depicted in its distended state and in a depressed state.

A transition of the teat 10 from its distended state into a depressed state, which may be effected by forced downwards movement of the nipple 14a into the areola 14b along the central axis L, e.g. as a result of underpressure within the interior food reception space 18, may give rise to the formation of an annular double fold or annular S-fold 32 in the teat wall 12. The double annular fold 32 may normally be absent in the distended state, and define an outer local maximum or hill 34 and an inner local minimum or well 36. Both the local maximum 34 and local minimum 36 may be annular and extend around a global maximum 38 defined by the nipple 14a of the teat 10. The portion of the teat wall 12 that, in a certain depressed state, defines the annular double fold 32 may be designated as the fold region 30 associated with that state. In a depressed state, the fold region 30 may range from the local maximum 34 to the local minimum 36 of the double fold 32, with the understanding the fold region 30 includes these local extrema 34, 36. The extrema 34, 36 may typically correspond to points of (local) maximum curvature, and thus to points of maximum deformation and elastic stress.

In general, a teat 10 may have multiple depressed states, each of which may be characterized by a fold region 30 of a certain width. This width may be measured in a radial/axial direction along the teat wall 12. Depressed states in which the nipple 14b is depressed further into the areola 14b may normally have a larger local maximum-to-local minimum distance, and hence a deeper fold 32 and a wider fold region 30. Because the fold region 30 may thus grow in width upon further depression of the nipple 14a, it may be preferable to define the fold region 30 with respect to a maximally depressed state, in which the nipple 14a is forced down into the areola 14b up to the point that the global maximum 38 it defines equals the local maximum 34 defined by the double fold 32. In such an embodiment, the fold region 30 may cover all fold regions associated with lesser depressed states.

During a transition of the teat 10 from the distended state to a depressed state, the relatively large area of the fold region 30 may be forcefully pressed through a confined annular underlying area, disposed in a plane transverse to the central axis L of the teat 10 and radially in between the later local maximum 34 and local minimum 36 of the double fold 32. The deformation of the fold region 30 may thus entail temporary displacement of wall material towards the central axis L of the teat 10, which may result in a compressive stress in the teat wall 12 in the tangential direction. Upon passing the annular underlying area, however, the stress in the teat wall 12 may be released, and the material in the fold region 30 may return to its approximate original diameter (i.e. its diameter in the distended state), beit at a different, lower axial position.

Although the distended state, in which the teat wall 12 is substantially relaxed, may represent an elastic-energy minimum that is lower than that of the depressed state, in which the teat wall 12 is partly deformed, the compressive state in between them may form a barrier to free transition. Accordingly, the distended state may be characterized as a stable equilibrium of the teat 10, while the depressed state may be characterized as a metastable equilibrium that is separated from the stable equilibrium by the intermediate compressive state. The metastability of the depressed state may in particular be present in conventional teat having a softened areola and a generally axisymmetric shape. This is because the elastic stresses in the fold region of the teat wall in such a teat may, on the one hand, be relatively small, and, on the other hand, be symmetrically distributed around the central axis. The symmetry may effectively raise the barrier defined by the compressive state (since the elastic deformation stresses counteract each other in attempts of the teat wall to relax), and leave elastic stresses in the wall incapable to effect the transition from the depressed state back to the distended state, thus fostering the metastability of the former.

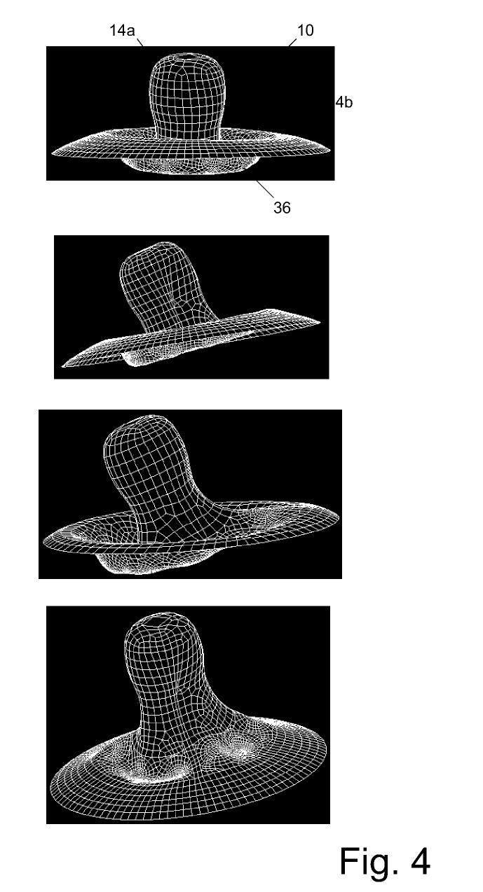

The teat according to the present invention overcomes the problem of metastability of the depressed state by introducing a rotationally asymmetric stiffness distribution in the fold region 30 of the teat wall 12, optionally without affecting either the general axisymmetric shape of the teat 10, or the sometimes desired softening of its areola 14b. The rotationally asymmetric stiffness distribution in the fold region 30 of the teat wall 12 ensures that, in an associated depressed state, an asymmetry exists in the elastic stresses that are present in the deformed wall 12. Fold region portions with a higher stiffness will exert greater (and thus partly unbalanced) restoring forces than fold region portions with a smaller stiffness, and thus force the nipple 14a out of the areola 14b through an asymmetrical transition path, which will be clarified below with reference to FIG. 4.

The rotationally asymmetric stiffness distribution of the teat wall 12 in the fold region 30 may be effected in different ways.

In one embodiment, the rotationally asymmetric stiffness distribution in the fold region 30 may be at least partially effected through a rotationally asymmetric wall thickness distribution in said region. For example, one (longitudinal) half of the teat wall 12 may have a thickness that is slightly different from that of the other (longitudinal) half of the teat wall 12. Alternatively, the fold region 30 may, for instance, include a rotationally asymmetric arrangement of wall thickness-defined structures, e.g. protrusions or recesses, either at the outer surface 12b of the teat wall 12, the inner surface 12a of the teat wall 12, or at both surfaces 12a, 12b. Wall-thickness defined structures at the inner surface 12a of the teat wall 12 may be preferred, as they may be of no consequence to the tactile and/or visual perception of the teat 10 during use. In principle, wall-thickness defined structures may have any suitable placement, shape, or size. In a preferred embodiment, a structure may disposed such that it extends across at least one of the local maximum 34 and the local minimum 36 of the annular double fold 32 when the teat 10 is in a depressed state. In such an embodiment the structure may be deployed very effectively since it may cover at least one of the points of maximum curvature and elastic stress. In another embodiment, a structure may be disposed such that it extends across substantially an entire width of a fold region 30, i.e. across at least 75% of the width of the fold region 30, and more preferably across at least 90% thereof, wherein the width may be measured in a radial/axial direction along the teat wall 12. Accordingly, it may prevent metastable retraction of the nipple 14a for the depressed state associated with that fold region 30, and any lesser depressed state.

In a preferred embodiment of the teat 10, such as the one depicted in FIGS. 1-3, the wall-thickness defined structure may take the form of an elongate rib 40b. In the illustrated embodiment, the inner surface 12a of the teat wall 12 defines three elongate, substantially radially/axially extending ribs 40a,b. The ribs 40a,b are tangentially equidistantly spaced apart at 120°, such that the placement of the ribs would in itself allow for rotational symmetry (see FIG. 2C). The ribs 40a,b, however, are not identical: rib 40b is thicker than ribs 40a in the sense that it protrudes further from the inner surface 12a of the teat wall 12 (see FIG. 2D). The arrangement of the ribs 40a,b is therefore rotationally asymmetrical. The cross-sectional view of FIG. 3B clearly shows that the rib 40b is partly disposed within the fold region 30 of the teat wall 12, and, more specifically, such that it extends across the local minimum 36 of the annular double fold 32 when the teat 10 is in a depressed state. An advantage of such a rib-shaped wall thickness-defined structure is that it may combine two functions: a lower portion thereof, i.e. the portion disposed within the fold region 30, may serve to avoid a metastable depressed state, while an upper portion thereof, i.e. the portion disposed within the neck 16b of the teat 10 and outside of the fold region 30, may serve to stiffen the neck so as to prevent it from collapsing.

By way of example, it is noted that, in an alternative embodiment, the rib 40b may have a same thickness as the other ribs 40a, but have a different length, for instance such that it extends across both the local minimum 36 and the local maximum 34 of the annular double fold 32 when the teat 10 is in a depressed state. In such an embodiment the non-uniform length of the ribs 40a, 40b may cause the rotationally asymmetric stiffness distribution, which in the concrete case may be effective because the extra long rib 40b extends across both points of maximum curvature of the double fold 32 while the short ribs 40a merely extend across the local minimum 36 thereof. A similar argument applies to an alternative embodiment wherein the rib 40b may have a (tangential) width different from the other ribs 40a, in which case the extra width of the rib 40b may result in extra unbending force. It is further understood that the above-described embodiments wherein a thickness, length or width of a rib 40b deviates from that of the other ribs 40a may also be combined so as to define a rib 40b having multiple geometric properties that deviate from those of the other ribs, or, more genenrally, to define a plurality of ribs 40a, 40b having multiple mutually deviating geometric properties.

The effectuation of a rotationally asymmetric stiffness distribution by means of wall thickness-defined structures offers the advantage that the teat 10 may be manufactured from a single, homogenous material, or at least a material having an elastic modulus that is homogenous throughout the wall 12. This benefits the economic manufacturability of the teat 10.

In another embodiment, however, the rotationally asymmetric stiffness distribution may be at least partially effected through the use of a rotationally asymmetric distribution of at least two materials having a mutually different modulus of elasticity. In such an embodiment the fold region 30 of the teat 10, which may be generally made of a first constituent material, may, for instance, include rotationally asymmetrically distributed ‘inlays’, portions or patches of a second constituent material having a modulus of elasticity that differs from that of the first. An advantage of such an embodiment is that it does not require shape-asymmetries to effect a rotationally asymmetric stiffness distribution in the belt region 30. As regards the placement, shape and size of the inlays, portions or patches, the above discussion of the wall thickness-defined structures is mutatis mutandis applicable.

The teat 10 may preferably be manufactured from a resilient material, such as, for instance rubber, latex, or liquid silicone rubber (LSR). In one embodiment, the teat 10 may be manufactured by injection molding, in which process the teat may be set or cured in its distended position, and provided with the capability and tendency to return to that position when it is distorted therefrom, in particular by depression.

Now that the construction of the teat 10 according to the present invention has been described in some detail, reference is made to FIG. 4 to illustrate the effect of a fold region 30 with a rotationally asymmetrical stiffness distribution. To this end, FIG. 4 schematically illustrates in four frames taken from a finite element modelling (FEM) simulation how the teat 10 of FIGS. 1-3 may elastically transform from its depressed state (top frame, cf. FIG. 3B) to almost back to its distended state (bottom frame, cf. FIG. 3A). In the FEM simulation the skirt 22 was omitted.

In the top frame the teat 10 is shown in a depressed state, in which it may held by a negative external-internal pressure differential across the wall 12 of the teat 10. When the pressure differential is removed and the teat 10 is released, the elastic stresses in in particular the local maximum 34 and local minimum 36 of the double fold 32 will act to force to the relatively large area of the fold region 30 through the confined annular overlying area, disposed in a plane transverse to the axis L of the teat 10 and radially in between the local maximum 34 and local minimum 36 of the double fold 32. Since the thicker rib 40b bent at the local minimum 36 (see FIG. 3B) has a relatively large stiffness and thus exerts a relatively large ‘unbending force’ that is rotationally unbalanced by that of the thinner ribs 40a, it will unbend first and tilt the nipple 14a out of its initial vertical position; see the second frame. In doing so, it allows the base of the neck 16b to pass through the aforementioned confined annular area first, as is shown in the third frame. When a first side of the teat 10 has been largely unbent, the less stiff areola portion still exhibiting the double fold 32 may similarly relax, thus allowing the teat 10 to pop out into its distended state. This is depicted in the fourth frame.

With regard to the terminology used in this text, the following is noted. Where the term ‘rotationally asymmetric’ is used with respect to a certain feature of the teat, e.g. a structure, arrangement, configuration, distribution, etc., the term may be construed to mean that said feature does not possess rotational symmetry of an order n>1 with respect to a central axis of the teat. Rotational symmetry of order n, also called n-fold rotational symmetry, or discrete rotational symmetry of the n-th order, with respect to a particular axis may mean that rotation by an angle of 360°/n around that axis effectively maps the feature onto itself. Rotational symmetry of (merely) order n=1 may thus effectively imply the absence of rotational symmetry, i.e. rotational asymmetry. The term ‘axisymmetry’ may be construed to refer to infinite-fold rotational symmetry; a feature that is axisymmetric with respect to a particular axis may map onto itself when rotated around that axis by any (arbitrary) angle. It is also noted here for clarity that a ‘modulus of elasticity’, such as in particular the Young's modulus, may be construed to be an intensive or material property, while ‘stiffness’ may be regarded to be an extensive or structural property.

Although illustrative embodiments of the present invention have been described above, in part with reference to the accompanying drawings, it is to be understood that the invention is not limited to these embodiments. Variations to the disclosed embodiments can be understood and effected by those skilled in the art in practicing the claimed invention, from a study of the drawings, the disclosure, and the appended claims Reference throughout this specification to “one embodiment” or “an embodiment” means that a particular feature, structure or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, it is noted that particular features, structures, or characteristics of one or more embodiments may be combined in any suitable manner to form new, not explicitly described embodiments.

### LIST OF ELEMENTS

1 infant feeding bottle
10 teat
12 resilient teat wall
12a inner surface of teat wall
12b outer surface of teat wall
14a nipple
14b areola
16a l head
16b neck
16c shoulder
18 interior food reception space
20 food discharge opening in nipple
22 skirt
24 annular groove in skirt for screw ring reception
26 clamp portion of skirt
28 oval recession in inner surface of areola
30 fold region of teat wall
32 annular double fold
34 annular local maximum/annular hill
36 annular local minimum/annular well
38 global maximum defined by nipple
40a thin rib
40b thick rib
50 screw ring
60 bottle body
L central axis

1. A teat for an infant feeding bottle, including a resilient wall defining a central nipple and an areola that extend around a central axis, said teat being elastically transformable between a distended state in which the nipple defines a global maximum and at least one depressed state that is accessible from the distended state by forcing the nipple at least partially into the areola along the central axis, and in which said wall additionally defines an annular double fold that is absent in the distended state and defines an outer local maximum and an inner local minimum, both extending circumferentially around the global maximum,
wherein the wall defines a circumferential fold region that, in said at least one depressed state, ranges from the local maximum to the local minimum of the double fold, and
wherein said fold region has a rotationally asymmetric stiffness distribution.
wherein that the rotationally asymmetric stiffness distribution in the fold region is:
(i) least partially effected through a plurality of elongate, tangentially equidistantly spaced-apart ribs that are arranged on an inner surface of the wall and defined by wall thickness-defined structures of said wall wherein at least one of the ribs has a different length and/or width and/or thickness than the other ribs, such that said ribs effect a rotationally asymmetric wall thickness distribution in said region, or
(ii) at least partially effected through the use of rotationally asymmetric distribution of at least two materials having a mutually different modulus of elasticity.

2. The teat according to claim 1, wherein the at least one depressed state is a maximally depressed state, in which the global maximum defined by the nipple is at a same axial position as the the local maximum defined by the double fold.

3. (canceled)

4. (canceled)

5. The teat according to claim 41, wherein the wall structure extends across at least 75% of the width of the fold region.

6. The teat according to claim 1, wherein the wall structure extends across at least one of the local maximum and the local minimum when the teat is in the at least one depressed state.

7. (canceled)

8. The teat according to claim 1, wherein the rib extends at least partly in both the fold region and a portion of a neck of the teat outside of the fold region.

9. (canceled)

10. The teat according to claim 5, wherein the resilient wall of the teat is at least partially made from liquid silicone rubber.

11. The teat according to claim 6, wherein an elastic modulus of a constituent material of the wall is homogeneous throughout the wall.

12. (canceled)

13. The teat according to claim 1, wherein the nipple defines a head, the areola defines a shoulder, and at least one of the areola and the nipple defines a neck that connects the head to the shoulder,
wherein the head has a maximum outer diameter D_{head,max}, wherein the neck (16b) has a minimum outer diameter D_{neck,min}, and wherein the shoulder has a minimum outer diameter D_{shoulder,min} and a maximum outer diameter D_{shoulder,max}, such that D_{shoulder,max}>D_{shoulder,min}>D_{head,max}≧D_{neck,min}.

14. The teat according to claim 1, wherein the wall of the areola of the teat defines a circumferential arrangement of a plurality of substantially identical and equidistantly spaced apart recesses.

15. An infant feeding bottle, including a teat according to claim 1.
